(19) United States
(12) Patent Application Publication
(10) Pub. No.: US 2008/0109357 A1
(43) Pub. Date: May 8, 2008

(54) SYSTEM AND METHOD FOR MONITORING COMMERCIAL TRANSACTIONS

(75) Inventor: Samuel N. Zellner, Dunwoody, GA (US)

Correspondence Address: MYERS BIGEL SIBLEY & SAJOVEC, P.A., P.O. BOX 37428, RALEIGH, NC, 27627, US

(73) Assignee: AT&T Delaware Intellectual Property, Inc.

(21) Appl. No.: 11/969,938

(22) Filed: Jan. 7, 2008

Related U.S. Application Data
(63) Continuation of application No. 09/608,184, filed on Jun. 30, 2000, now abandoned.

(51) Int. Cl. G06Q 40/00; G06Q 20/00

(52) U.S. Cl. 705/44; 705/39; 705/35

(57) ABSTRACT

Commercial transactions are monitored by sending a notification of the transaction to the person responsible for paying for the transaction during the occurrence of the transaction. Preferably, the notification is sent when a request for authorizing the commercial transaction is sent to an authorizing entity. In one embodiment of the invention, the person responsible for paying for the commercial transaction can approve the transaction prior to its authorization. The notification can be to any device including a pager, email, facsimile, cellular or other telephone device, personal computer, internet appliance and personal digital assistant, or a voicemail. The notification is performed by sending the notification message to the notification device using one of the following notification addresses as appropriate: a pager number, email address, or other address for notifying the payer, including, for example, a cellular telephone or other telephone number, a facsimile number, an Internet protocol (IP) address, including Internet appliances and an instant messaging address. The notification is by Notification can be suspended at the option of the user and thresholds for notification can be set by the user.

### CROSS-REFERENCE TO RELATED APPLICATION

This application is a continuation of application Ser. No. 09/608,184, filed Jun. 30, 2000, assigned to the assignee of the present application, the disclosure of which is hereby incorporated herein by reference in its entirety as if set forth fully herein.

### FIELD OF INVENTION

The present invention is related to reducing fraud in commercial transactions. More specifically, the present invention is related to monitoring commercial transactions at or near the time of their occurrence by providing a notification message of the commercial transaction to the person or entity responsible for paying for the commercial transaction.

### BACKGROUND OF THE INVENTION

A significant problem facing participants in commercial transactions is the possibility of fraud. In the case of credit card transactions, for example, the merchant from whom an item is purchased using a credit card has no reliable way of verifying that the user of the card is authorized to use it. Identification sources such as the signature that is supposed to be on the back of the credit card can be missing, not checked or forged. Thus, the store has virtually no way of knowing if the credit card is being used in a fraudulent manner, for example, after being stolen or found by someone not authorized to use it. As a result such crimes often go unreported and undetected at the time of the commercial transaction.

In fact, in many cases the fraudulent use of the credit card is not discovered until the person or entity responsible for paying for the commercial transaction (the “payer”) receives a statement containing all transactions that occurred during some time period, usually a month. If the statement is not carefully checked, the crime may go undetected for a significantly longer period. If the fraudulent use of the credit card is discovered, the unauthorized use of the card is reported to a credit card company, generally the company that issued the card. In most cases, the credit card company simply nullifies the transaction in its records, thereby incurring a loss of the value of the transaction. Considering the large number of commercial transactions, such fraud can cost credit card companies and other authorizers of commercial transactions enormous sums of money, easily topping tens or hundreds of millions of dollars.

One way that credit card companies attempt to discover fraudulent transactions is by monitoring buying patterns of the credit card holders. That is, if a person generally buys small items, for example, items having a value less than $20.00, the credit card company might question a purchase of an item costing $1000.00. However, this sort of check by the credit card company is sporadic at best and generally unsuccessful at uncovering a significant number of unauthorized or fraudulent transactions.

Fraud is not the only problem facing payers of commercial transactions. There is a significant problem with unauthorized transactions. For example, children are often given credit cards for use only in the event of an emergency. However, the children may use the cards for purchases that are not related to any emergency, for example, a compact disk. Parents would often like to know of these transactions when they occur, not when the credit card statement comes at the end of the month. This is not possible in conventional credit card transactions.

Conventional messaging systems can provide an alert to subscribers upon the receipt of a message intended for the subscriber. For example, email systems alert subscribers upon the receipt of an email. Similarly, phone mail systems can alert subscribers of the receipt of a phone mail message. These sorts of systems can be exemplified by conventional unified messaging systems in which a page is sent to a subscriber indicating the receipt of a message (email, fax or voice) in a subscriber's mailbox.

An example convention unified messaging system 102 system using alerts upon events is illustrated schematically in FIG. 1. Unified messaging system (UMS) 102 receives a facsimile message in a subscriber's mailbox 103. UMS 102 notifies the subscriber of receipt of the facsimile message through a pager 104 used by the subscriber. When UMS 102 receives a message such as a facsimile message, the unified messaging systems generates a message to a paging service 106 through a network 108. In this case, network 108 is a public-switched telephone network. UMS 102 transmits a pager number, associated with subscriber's mailbox 103 and an alert message indicating receipt of the facsimile message to paging service 106. Paging service 106 includes a paging server 110 to process paging requests. Paging service 106 transmits the alert message to pager 104, thereby notifying the user of pager 104 of the receipt of the facsimile message in UMS 102.

Alternately, UMS 102 transmits a pager identification number associated with subscriber mailbox 103 along with the alert message indicating receipt of the facsimile message to be sent to pager 104 to paging service 106. Paging service 106 then sends the alert message indicating receipt of the facsimile message to pager 104.

UMS 102 can notify the subscriber of receipt of the facsimile message in several other ways as well. For example, UMS 102 can send an email to paging server 110 through network 108 containing an identification of the pager associated with the subscriber's mailbox and an alert message indicating receipt of the facsimile message to be sent to pager 104. In this case, network 108 is a computer network such as the Internet. Paging service 106 then transmits the page to pager 104 identified in the email message.

UMS 102 can also notify the subscriber of the receipt of the facsimile message by sending the subscriber a facsimile message indicating receipt of the fax, by sending the subscriber an email indicating receipt of the message, or by initiating a phone call to the subscriber's telephone or cellular telephone and playing an alert message to the subscriber when the call is answered, or leaving voicemail if the telephone is answered by an answering machine. The foregoing techniques for notifying the user are well known to those skilled in the art.

### SUMMARY OF THE INVENTION

The present invention addresses the problems associated with fraud in conventional commercial transactions by providing a system and method for monitoring commercial transactions at the time they occur. In the preferred embodiment, the person or entity responsible for paying for the commercial transaction (the “payer”) is notified of the occurrence of the commercial transaction during the commercial transaction. In the preferred embodiment of the present invention, the payer is notified when authorization for the commercial transaction is requested.

For example, in commercial transactions involving credit card purchases, the payer is notified of the transaction at the time of the transaction. In a preferred embodiment, the notification occurs at the time that authorization for the purchase is requested from the credit card company. In this manner, the present invention provides a monitoring function for a commercial transaction so that the payer is notified that the transaction is occurring.

In an alternate embodiment, the payer is asked to approve the commercial transaction prior to its being completed. Preferably, the approval is requested prior to authorization of the commercial transaction. If the payer approves the commercial transaction, it is processed; otherwise, it is stopped.

Further, in a preferred embodiment of the present invention, the payer is notified of the commercial transaction only upon meeting a transaction threshold amount or filter definition. Alternatively, the notification function can be suspended for any length of time. For example, a transaction threshold amount for the notification. If the amount of the transaction is below the transaction threshold amount, the payer is not notified of the occurrence of the commercial transaction. Additionally, if the approval option is activated, there would be no approval request unless the transaction threshold amount has been exceeded.

Thus, the present invention provides a monitoring of the commercial transactions substantially closer in time to their occurrence than conventional commercial transactions. Moreover, the present invention permits “remote” approval of the transaction. That is, the payer can approve the transaction at the time the transaction is being conducted even when the payer is not present at the site of the commercial transaction.

In a preferred embodiment of the present invention, notification is by page message sent to a pager used by the payer. However, it would be apparent that any method of notification that occurs substantially close in time to the transaction can be used within the scope and spirit of the present invention. For example, a telephone call can be initiated to the person at a telephone or cell phone, voicemail can be left, an email can be sent to the person, a fax can be sent to the person.

In addition, the person or company responsible for paying for the commercial transaction has the option of deactivating the monitoring and approval functions of the present invention.

Thus, one object of the present invention is to reduce losses due to fraud in commercial transactions.

Another object of the present invention is to monitor commercial transactions at or near the time of their occurrence.

Another object of the present invention is to reduce unauthorized commercial transactions.

Another object of the present invention is provide for approval of commercial transactions before they proceed.

Another object of the present invention is to provide substantially real-time notification of a commercial transaction to the payer.

Another object of the present invention is to provide substantially real-time notification to the payer of account activity resulting from commercial transactions.

These and other objects of the present invention are described in greater detail in the detailed description of the invention, the appended drawings and the attached claims.

### BRIEF DESCRIPTION OF THE DRAWINGS

FIG. 1 is a schematic diagram of a conventional system for providing an alert message upon the occurrence of an event such as the receipt of a facsimile message.

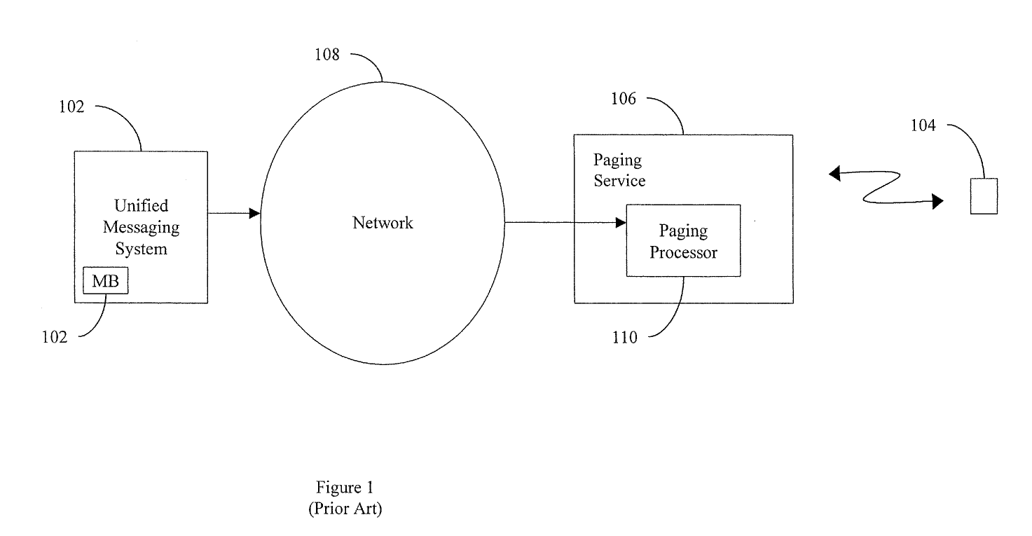

FIG. 2 is a schematic diagram of a system for monitoring commercial transactions according to a preferred embodiment of the present invention.

FIG. 3 is a flow chart for a process for monitoring commercial transactions according to a preferred embodiment of the present invention.

FIG. 4 is a flow chart for a process for acquiring approval for a commercial transaction prior to proceeding with the commercial transaction.

### DETAILED DESCRIPTION OF THE PREFERRED EMBODIMENTS

The present invention provides monitoring of commercial transactions at or near the time of their occurrence. In the preferred embodiment of the present invention, the person or entity responsible for paying for a commercial transaction (the “payer”) is notified of the commercial transaction during or soon after the commercial transaction occurs. The payer does not have to be the owner of the credit card. Consequently, the payer is aware of any transaction for which he may be responsible when that transaction is taking place or shortly thereafter. If the payer has not authorized the transaction, for example, the transaction is being conducted with a counterfeit or lost credit card or other purported authority for the transaction, the payer can contact an appropriate authority, and advise them that an illegal transaction is taking place. Because the authority is contacted at or very close to the time of the transaction, the authority has a better chance to catch the party committing the fraud, and prevent substantial losses resulting from such frauds.

In another preferred embodiment, the payer is given the opportunity to approve the transaction. Thus, the transaction is suspended while the payer is notified of the attempted transaction. If the payer approves the transaction, the transaction proceeds, otherwise the transaction does not proceed.

The present invention will be described in more detail with reference to credit card transactions. However, it would be apparent to those skilled in the art that the system and method disclosed herein apply to any commercial transactions where authorization is required, including card initiated transactions such as credit card, ATM and diner's club transactions, and E-commerce transactions, including commercial transactions over the Internet and on-line banking transactions.

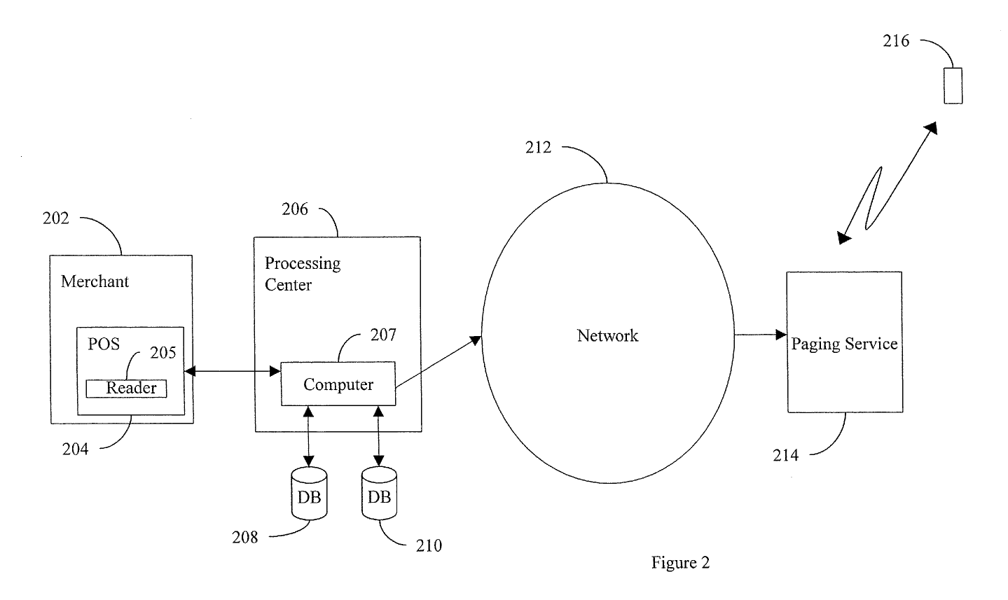

FIG. 2 is a schematic diagram of a preferred embodiment of the present invention for monitoring commercial transactions. The system illustrated in FIG. 2 is described with respect to credit card transactions, but can be used for any commercial transactions as described above. In FIG. 2, there is a merchant 202 having a point of sale device 204. Point of sale device 202 can be a well-known cash register having credit card input device such as credit card reader 205 in which the commercial transaction is initiated.

When a customer attempts to make a purchase using a credit card, credit card reader 205 obtains data from the credit card and sends it to a computer 207 located in a processing center 206 associated with the credit card provider. Computer 207 can be any computer capable of carrying out the processing described in the present specification. Such computers are well-known to those skilled in the art and need not be described further. The data sent to computer 207 typically includes merchant identification data, the amount of the transaction, the credit card number and date and time of the transaction. Computer 207 uses the data to determine whether it should authorize the transaction. For example, computer 207 uses the credit card number and transaction amount to perform a database lookup in a database 208 to determine whether the transaction exceeds the credit limit of the credit card. If the transaction is to be authorized (i.e., the credit limit has not been exceeded), computer 207 appropriately records the transaction, for example, debits the credit card account by the amount of the transaction, and transmits a reference number and authorization code to point of sale device 204. The reference number is a number that is used to identify the particular credit card transaction. The authorization code advises merchant 202 that the transaction has been authorized and the sale can be completed.

According to a preferred embodiment of the present invention, database 208 also contains data indicating whether payer of the credit card subscribes to a monitoring service. If the payer subscribes to the monitoring service, then, substantially simultaneously with sending the reference number and authorization code to point of sale device 204, processing center 206 notifies the payer that the transaction is taking place.

To perform this notification, computer 207 accesses a second database, for example, database 210. Database 210 contains entries that associate credit card numbers with a notification address. The notification address can be a pager number, email address, or other address for notifying the payer, including, for example, a cellular telephone or other telephone number, a facsimile number, an Internet protocol (IP) address, including Internet appliances and an instant messaging address. The email address can be the email address of a pager. These notification addresses correspond to one or more of the following devices: a pager, email, facsimile, cellular or other telephone device, personal computer, internet appliance and personal digital assistant, or a voicemail. It should be noted that those skilled in the art would be aware of other notification methods and devices that can be used within the scope and spirit of the present invention.

Computer 207 sends the credit card number to database 210 in a notification address query to obtain the notification address associated with the credit card involved in the transaction. In response to the notification address query, database 210 returns the notification address associated with the credit card number to computer 207.

After receiving the notification address from database 210, computer 207 sends a notification message to the payer to notify the payer that the transaction is occurring. In the preferred embodiment of the present invention, the notification message includes the following information: the merchant name (or merchant ID number), merchant address, amount of the transaction, data and time of the transaction, name on credit card, help number (to report criminal activity, e.g., phone number of credit card company), whether transaction was authorized or denied, and the reference number of the transaction. The information in the notification message is similar to the information that the payer receives in the periodic statement of transactions.

The form of the notification message depends on the way that the notification message is sent from the processing center to the payer. In the preferred embodiment of the present invention, the notification message is sent in a page to a pager 216 used by the payer or via an email to a paging service 214 through a network 212. Preferably, network 212 is a computer network such as the Internet. Paging service 214 then sends a page containing the notification message to pager 216. In an alternate preferred embodiment of the present invention, the notification message is sent as an email to an email address returned in the notification address query. The payer receives notification of the transaction via an email message.

In an alternate preferred embodiment, computer 207 receives a telephone number in the response to the notification address query. In this case, computer 207 initiates a telephone call to the telephone number, and transmits the information of the notify message through a voice synthesizer or other text to speech processor. In this case, network 212 is a telephone network such as the public-switched telephone network. It would be apparent to those skilled in the art that any desired information, including, but not limited to that described above, can be sent in the notification message. For example, in the case of notification by telephone message, computer 207 may send only information sufficient to notify the payer of the fact that the transaction is occurring.

In a preferred embodiment of the present invention, a transaction threshold amount can be established. Preferably, the transaction threshold amount is established by the payer or the monitoring service provider. If a given transaction does not exceed the transaction threshold amount, then no notification message is sent despite the occurrence of the commercial transaction. Alternatively, the transaction threshold amount can correspond to some aggregate amount in a given time period. If the transaction does not cause the threshold amount to be exceeded in the given time period, no notification message is sent.

In an alternative embodiment of the present invention, a filter can be established. To establish a filter, a filter definition is created. Examples of such filter definitions include transactions at a certain merchant, transactions by a particular card number and transactions by a particular person or entity. Preferably, the filter definition is established by the payer or the monitoring service provider. The message is sent only if the filter definition is met, for example, the transaction is by the particular merchant defined in the filter, or by the card having the particular card number or the person or entity defined in the filter. It would be apparent to those skilled in the art that any combination of filter definitions can be established. Further, it would be apparent to those skilled in the art that any combination of the transaction threshold amount and filter can be established.

In a preferred embodiment of the present invention, the notification can be suspended at the option of the payer or monitoring service provider. The suspension can be for any length of time and for any reason.

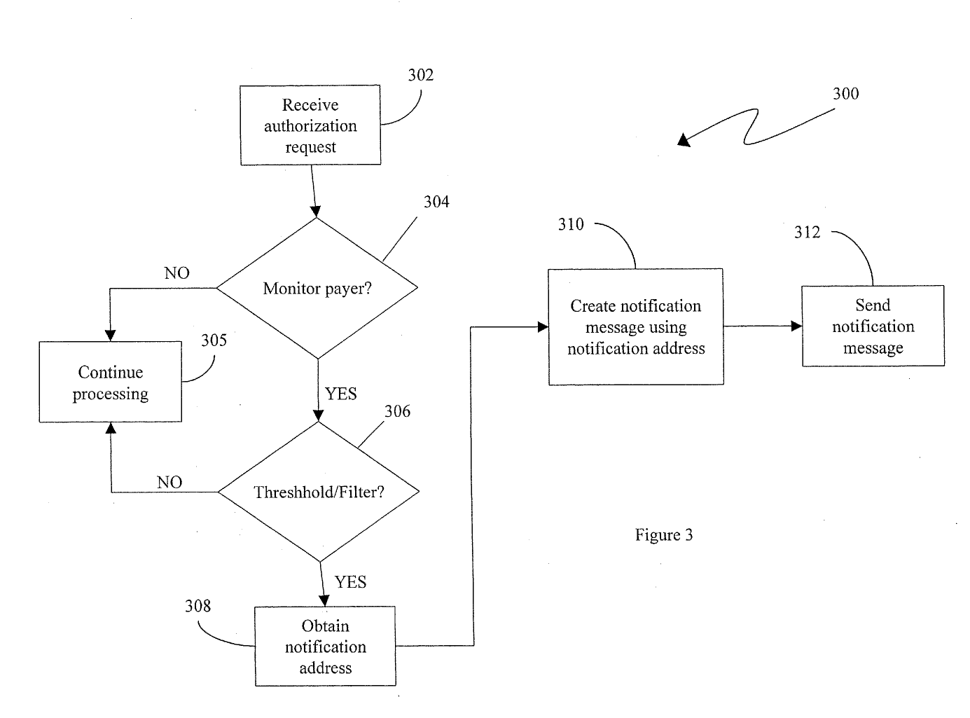

FIG. 3 is a flow chart showing a process 300 according to a preferred embodiment of the present invention. Process 300 can execute on any computer, for example, computer 207. During processing of a commercial transaction, for example, using a credit card, an authorization request is sent to computer 207 to obtain authorization to proceed with the commercial transaction. In step 302, process 300 receives the authorization request. In step 304, process 300 determines whether the payer associated with the identification number received in the authorization request has subscribed to the commercial transaction monitoring service. Preferably, this determination is made by querying database 208 to determine whether the payer subscribes to the monitoring service. If the payer has not subscribed to the commercial transaction monitoring service, processing of the commercial transaction continues in step 305. If the payer has subscribed to the commercial transaction monitoring service, process 300 determines whether any thresholds have been exceeded or filters definitions have not been met in step 306. If a threshold has been exceeded or a filter definition has not been met, processing of the commercial transaction continues as in conventional system in step 305. If no threshold has been exceeded and all filter definitions have been met, process 300 obtains a notification address from database 210 in step 308. Using the obtained notification address, process 300 creates a notification message as described above in step 310. The notification message is sent to the notification address to notify the payer of the commercial transaction in step 312.

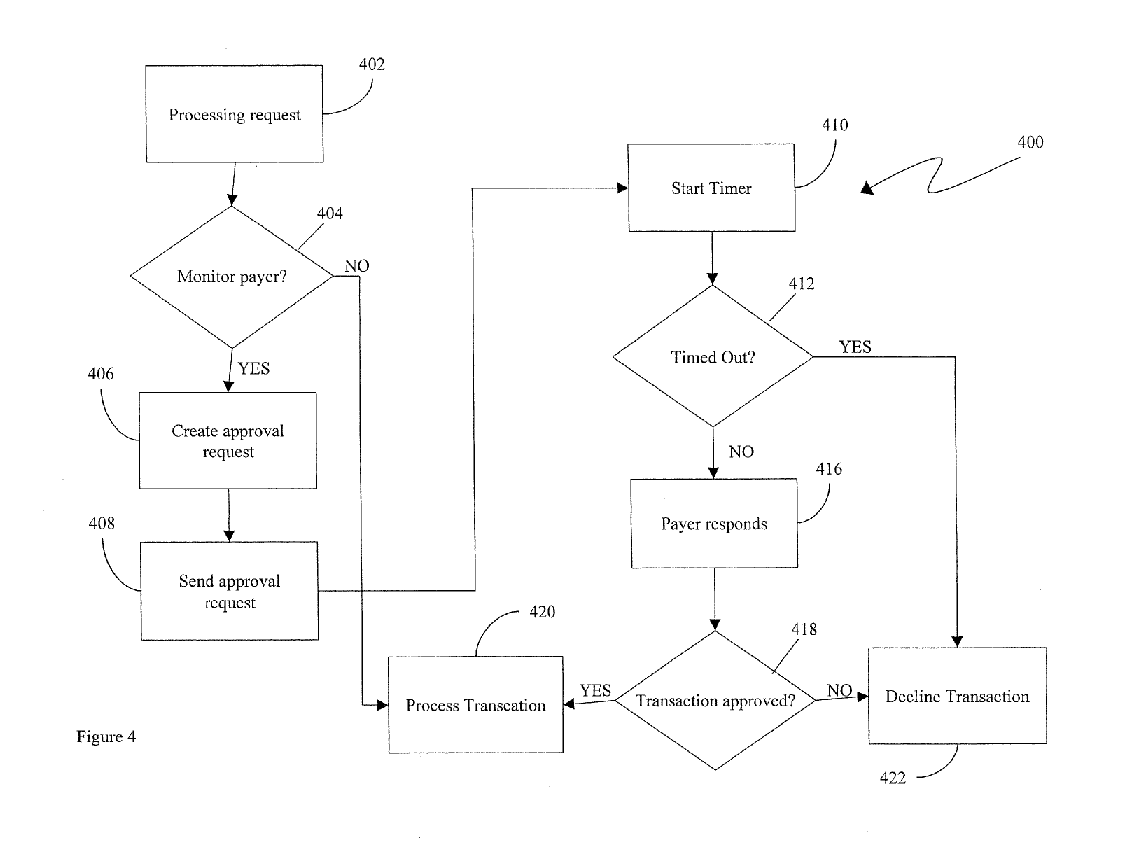

FIG. 4 is a flow chart for a process 400 for obtaining approval of a commercial transaction prior to continuing the processing. Process 400 can execute on any computer including, for example, computer 207. In step 402, process 400 receives a request to process a transaction. In step 404, computer 207 determines whether the payer subscribes to a monitoring function, in this case, an approval function. If the payer does not subscribe to the monitoring service, the processing of the transaction continues in step 420. If the payer subscribes to the monitoring service, computer 207 creates an approval request in step 406. The approval request is a message that contains information the payer can use to determine whether to provide approval for the commercial transaction. In the preferred embodiment, the information includes the amount of the transaction, the merchant's name (or merchant ID), and the date and time of the commercial transaction.

In step 408, the approval request is sent to the payer. The approval request can be sent in any of the manners described above, including for example, by page, email, and telephone call. In the preferred embodiment, process 400 starts a timer in step 410. The timer is set to expire after a pre-determined amount of time without an approval from the payer. The timer prevents the approval process from taking unreasonably long. The length of the timer can be set to any arbitrary value. If the timer times out in step 412, then process 400 performs a default action. In the preferred embodiment of the present invention, the default action is to decline the transaction in step 422. If the subscriber responds in step 416 prior to the timer timing out in step 412, process 400 determines whether the subscriber approved the transaction in step 418. If the subscriber approved the transaction in step 418, process 400 continues processing the transaction in step 420. If the subscriber does not approve the transaction in step 418, process 400 declines the transaction in step 422.

It should be noted that the present invention can be used to monitor account activity in general. For example, in the case of credit cards, item are often returned for a credit to the credit card account. Through the notification feature described above for the present invention, the payer can be notified virtually at the instant that the account has been credited of the credit. This provides immediate confirmation to the payer that return of the item has indeed been registered and his account appropriately credited. Likewise, in the case of ATM or on-line banking transactions, the present invention allows any account activity to be monitored substantially in real-time, whether deposit, withdraw or balance inquiries. In these cases, the payer is the bank account holder and the bank is the processing center. Any unauthorized account activity can be deleted a the time of the activity on the account. Because there is contact information in the notification message, the account holder can notify the appropriate authority in the event of unauthorized access, at the time the account is accessed.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed is:

1. A transaction processing center comprising:
an electronic banking system that is configured to process electronic banking transactions including balance inquiry transactions for bank accounts; and
a monitoring system that is configured to send a balance inquiry notification message to a bank account holder of a given bank account to notify the bank account holder that a balance inquiry was made for the given bank account.

2. A transaction processing center according to claim 1 wherein the balance inquiry notification message further includes contact information for the electronic banking system and wherein the electronic banking system is further configured to receive and process a message from the bank account holder that the balance inquiry for the given bank account was unauthorized.

3. A transaction processing center according to claim 1 wherein the electronic banking transactions include automatic teller machine transactions and online banking transactions.

4. A transaction processing center according to claim 1 wherein the electronic banking transactions include deposit and withdrawal transactions for the bank accounts.

5. A transaction processing center comprising:
a credit card account processing system that is configured to receive a credit indication that an item has been returned for credit and to electronically credit a credit card account of a credit card payer of the item that has been returned for credit in response to the credit indication; and
a monitoring system that is configured to send an electronic credit confirmation message to the credit card account payer including notification that the credit card account of the credit card payer has been electronically credited, in immediate response to the electronic credit of the credit card account of the credit card payer by the credit card account processing system.

6. A transaction processing center according to claim 5 wherein the electronic credit confirmation message contains therein an identification of the item that was returned.

7. A transaction processing center according to claim 5 wherein the electronic credit confirmation message further includes contact information for the credit card account processing system and wherein the credit card account processing system is further configured to receive and process a message from the credit card account payer that the return of the item for credit was unauthorized.

8. A transaction processing center according to claim 5:
wherein the credit card account processing system is further configured to receive a purchase indication that an item has been purchased with credit and to electronically debit a credit card account of a credit card payer of the item that has been purchased with credit in response to the purchase indication; and
wherein the monitoring system is further configured to send an electronic debit confirmation message to the credit card account payer including notification that the credit card account of the credit card payer has been electronically debited, in immediate response to the electronic debit of the credit card account of the credit card payer by the credit card account processing system.

9. A transaction processing center according to claim 8 wherein the electronic debit confirmation message contains therein an identification of the item that was purchased.

10. A transaction processing center according to claim 8 wherein the electronic debit confirmation message further includes contact information for the credit card account processing system and wherein the credit card account processing system is further configured to receive and process a message from the credit card account payer that the purchase of the item for credit was unauthorized.

11. A transaction processing center according to claim 7:
wherein the credit card account processing system is further configured to receive a purchase indication that an item has been purchased with credit and to electronically debit a credit card account of a credit card payer of the item that has been purchased with credit in response to the purchase indication; and
wherein the monitoring system is further configured to send an electronic debit confirmation message to the credit card account payer including notification that the credit card account of the credit card payer has been electronically debited, in immediate response to the electronic debit of the credit card account of the credit card payer by the credit card account processing system.

12. A transaction processing center according to claim 11 wherein the electronic debit confirmation message further includes contact information for the credit card account processing system and wherein the credit card account processing system is further configured to receive and process a message from the credit card account payer that the purchase of the item for credit was unauthorized.

13. A transaction processing method comprising:
receiving a credit indication that an item has been returned for credit;
electronically crediting a credit card account of a credit card payer of the item that has been returned for credit in response to the credit indication; and
sending an electronic credit confirmation message to the credit card account payer including notification that the credit card account of the credit card payer has been electronically credited, in immediate response to the electronically crediting the credit card account of the credit card payer.

14. A transaction processing method according to claim 13 wherein the electronic credit confirmation message contains therein an identification of the item that was returned.

15. A transaction processing method according to claim 13 wherein the electronic credit confirmation message further includes contact information and wherein the method further comprises receiving and processing a message from the credit card account payer that the return of the item for credit was unauthorized.

16. A transaction processing method according to claim 13 further comprising:
receiving a purchase indication that an item has been purchased with credit;
electronically debiting a credit card account of a credit card payer of the item that has been purchased with credit in response to the purchase indication; and
sending an electronic debit confirmation message to the credit card account payer including notification that the credit card account of the credit card payer has been electronically debited, in immediate response to the electronic debit of the credit card account of the credit card payer.

17. A transaction processing method according to claim 16 wherein the electronic debit confirmation message contains therein an identification of the item that was purchased.

18. A transaction processing center according to claim 16 wherein the electronic debit confirmation message further includes contact information and wherein the method further comprises receiving and processing a message from the credit card account payer that the purchase of the item for credit was unauthorized.

19. A transaction processing method according to claim 15 further comprising:
receiving a purchase indication that an item has been purchased with credit;
electronically debiting a credit card account of a credit card payer of the item that has been purchased with credit in response to the purchase indication; and
sending an electronic debit confirmation message to the credit card account payer including notification that the credit card account of the credit card payer has been electronically debited, in immediate response to the electronic debit of the credit card account of the credit card payer.

20. A transaction processing center according to claim 19 wherein the electronic debit confirmation message further includes contact information and wherein the method further comprises receiving and processing a message from the credit card account payer that the purchase of the item for credit was unauthorized.
